(19) United States
(12) Patent Application Publication
(10) Pub. No.: US 2010/0228168 A1
(43) Pub. Date: Sep. 9, 2010

(54) FOOT RECIPROCATING MASSAGING DEVICE

(76) Inventors: Kelin Xu, Tianjin (CN); Shulin Ning, Tianjin (CN)

Correspondence Address: WANG & HO, 66 HILLTOP ROAD, MILLINGTON, NJ, 07946, US

(21) Appl. No.: 12/295,294

(22) PCT Filed: Mar. 29, 2007
(86) PCT No.: PCT/CN07/01020

§ 371 Date: Sep. 13, 2009

(30) Foreign Application Priority Data
Mar. 31, 2006 (CN) 200620025674.8

(51) Int. Cl. A61H 7/00

(52) U.S. Cl. 601/104

(57) ABSTRACT

The present invention discloses a reciprocating type foot massage device which can promote the blood circulation of feet so as to achieve the effect of feet treatment and health care by a way that a plurality of massage wheels conduct a reciprocal arcus rising movement at the planta pedis. The device comprises a motor and a massage part situated in a hole of a support plate. Two groups of symmetrical motion control parts are arranged beneath the support plate. Each motion control part is composed of a wheel disk on the shaft of the motor, a pin at an eccentric position on the wheel disk, a connecting rod and a rocking beam connected in turn. The connecting rod is connected to the middle of the rocking beam. A massage wheel is arranged at the upper end of the rocking beam. Each group of motion control parts comprise 2˜3 kits, and are distributed laterally in parallel. The width of the distributed area of each group of motion control parts is 5˜10 cm. The eccentric distances of the pins on each group of wheel disks increment in turn laterally. Each group of rocking beams increment laterally. The massage wheels adopt an elastic material. On the surface of the massage wheel is arranged a mastoid process, a heating device, a medicine underlayer or a magnetic material.

### CROSS REFERENCE TO RELATED APPLICATIONS

This is a national phase of PCT Application No. PCT/CN2007/001020, filed Mar. 29, 2007, which claims benefit of Chinese Application No. 200620025674.8, filed Mar. 31, 2006, the contents of which are incorporated herein in its entirely by reference.

### FILED OF THE INVENTION

The present invention relates to a human body health care device, particularly to a human foot health care device.

### BACKGROUND OF THE INVENTION

Chinese traditional medicine holds that the decrepitude of a person begins from his foot, because the planta pedis is the second heart of the human body, on which come together the reflex regions of various organs of the human body, i.e. the planta pedis is the convergent point of various organs of the human body. By massaging and stimulating the flesh and the blood vessel of a certain reflex region, its function can be restored. The meridian doctrine of the traditional Chinese medicine holds that the foot is a region through which three yang channels and the three yin channels of the feet pass, and the planta pedis and the toe are their terminals, constitute the exterior and interior at convergence and syntaxis positions, run through various regions of the whole human body, and blends with each other. Further, the anatomy of western medicine holds that the blood vessels of the foot are very rich. In general, we have such an experience that, by washing the feet with warm water and massaging the feet to the point, it is favorable for blood circulation and can achieve the effect of removing diseases, building health and making the human body be in very good nick.

Along with the increase of the living standard of people, the health care sense of people is gradually strengthen, people pay more and more attention to the health care of the planta pedis, and the planta pedis massage has been blended into the daily life of people. Thus a foot washing service profession is prevalent in the current society, which achieves the effect of relieving fatigue and making the human body strong and healthy. But since its environment is a public place and its sanitary condition is uneasy to control, various skin diseases are easy to be aroused. In order to be able to not only massage the planta pedis, but also avoid the infection of various skin diseases, various planta pedis massage appliances appears one after another. Currently, most planta pedis massage appliances commercially available are apron type planta pedis masseur, most of their massage manners are single shaking massage, and there exist disadvantages that the massage manners are hidebound, the feeling is not comfortable and the massage pertinence with respect to the planta pedis acupuncture points is not strong, difficult to satisfy the use requirements of users.

### SUMMARY OF THE INVENTION

In order to overcome the deficiency in the prior art, the present invention provides a reciprocating type foot massage device which can promote the blood circulation of feet so as to achieve the effect of feet treatment and health care by a way that a plurality of massage wheels conduct a reciprocal arcus rising movement at the planta pedis. It makes the reciprocal rising massage wheels apply repeated roll, push and press to the planta pedis in virtue of the downward natural pressure of the feet of the human body, simulates realistically the actions of manually pushing, twisting and pressing the planta pedis by fingers, and stroke the muscle and skin of the planta pedis and massage the acupuncture point over a large area.

In order to solve the above technical problem, the present invention is implemented by using the following technical solution. The reciprocal foot massage device according to the present invention comprises a motor and a massage part situated in a hole of a support plate. Two groups of symmetrical motion control parts are arranged beneath the support plate. Each motion control part is composed of a wheel disk on the shaft of the motor, a pin at an eccentric position on the wheel disk, a connecting rod and a rocking beam connected in turn. The connecting rod is connected to the middle of the rocking beam. A massage wheel is arranged at the upper end of the rocking beam. Each group of motion control parts comprise 2˜3 kits, and are distributed laterally in parallel.

In the reciprocal foot massage device according to the present invention, the width of the distributed area of each group of motion control parts is 5˜10 cm. The eccentric distances of the pins on each group of wheel disks increment in turn laterally. Each group of rocking beams increment laterally. The massage wheels adopt an elastic material. On the surface of the massage wheel is arranged a mastoid process, a heating device, a medicine underlayer or a magnetic material.

Compared to the prior art, the present invention has the following advantageous effects:

(1) Since the reciprocal foot massage device according to the present invention has a reasonable structure design, particularly the motion control parts therein adopt a crank link mechanism, thus making the rising altitude of the plurality of massage wheels distributed laterally conform to the lateral curve of the planta pedis. So, in virtue of the self weight of the feet of human body, the massage process can be made to simulate realistically the actions of manually pushing, twisting and pressing the planta pedis by fingers, and there is a process of remitting releasing strength in the process of the massage wheels' reciprocal pushing and pressing backwards and forwards, which overcomes a phenomenon that general unidirectional roll, push and press is easy to rub the muscle and skin of the planta pedis excessively, makes a person to clear and activate the channels and collaterals in a scenario felt very comfortable, and promotes the blood circulation of the feet.

(2) The massage wheels in the reciprocal foot massage device according to the present invention adopts a multiple-row laterally parallel distribution. The curved surface shape of the planta pedis is adapted under the effect of the massage wheels at different positions and different altitudes. This can ensure to reach the strength of stimulating a local region and to simulate realistically the actions of manually pushing, twisting and pressing the planta pedis by fingers without consuming physical strength and without double hands massage, thus achieving the health care effect of adjusting the human body faculty and promoting the metabolism of the human body.

(3) On the surface of the cydariform massage wheels can be optionally arranged a mastoid process structure, a heating and heat preservation device or a covering medicine underlayer, or be arranged a magnetic point, thus in the meantime of massage, taking such multiple physical therapy functions as heat, force, magnetism or medicine, promoting the telangiectasia and the blood and breath fluence of feet, stimulating the acupuncture points of the reflex regions of the planta pedis, and taking the effects of prophylaxis, disease treatment and health improvement.

### BRIEF DESCRIPTION OF DRAWINGS

FIG. 1 is a front view of the structure of the reciprocal foot massage device according to the present invention;

FIG. 2 is a side view of the regions of the rocking beam and the massage wheels shown in FIG. 1; and

FIG. 3 is a top view of the regions of the long hole, the rocking beam and the massage wheels shown in FIG. 2.

The following is the description of the main numerical references in the drawings of the specification of the present invention:

| 11--support plate | 12--long hole | 21--wheel disk |
|---|---|---|
| 22--pin | 23--connecting rod | 24--rocking beam |
| 25--shaft of motor | 26--rocking beam fixing shaft | |
| 27--connection point | 31--massage wheel | 32--hinge. |

### DETAILED DESCRIPTION OF PARTICULAR EMBODIMENTS OF THE INVENTION

The present invention will be further detailed below in conjunction with the drawing and the best modes for carrying out the invention.

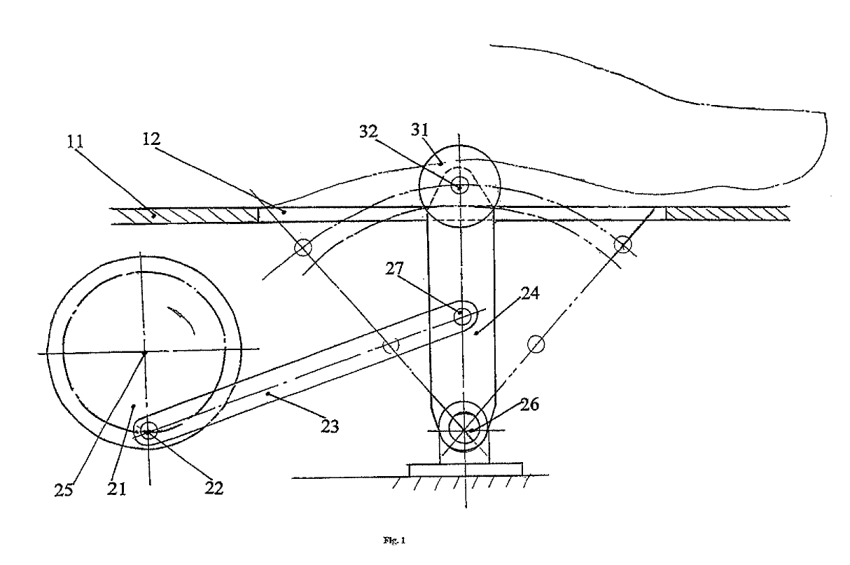

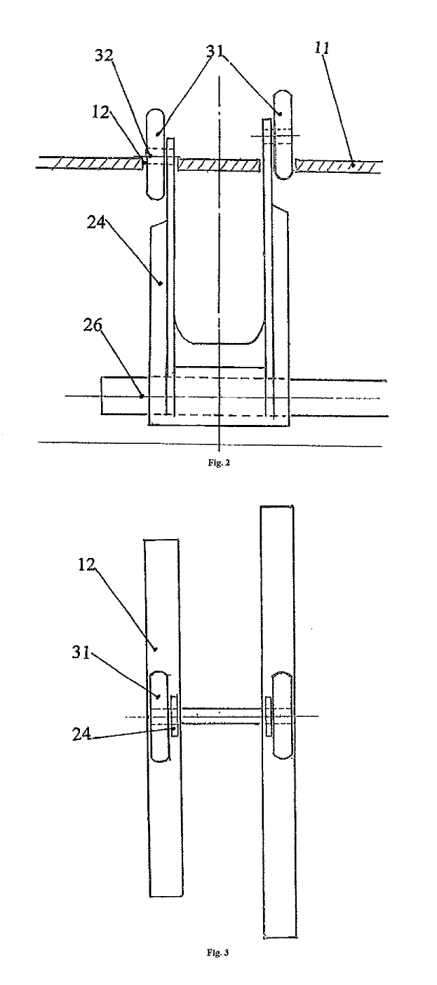

As shown in FIGS. 1, 2 and 3,

The reciprocal foot massage device according to the present invention comprises a motor and a massage part situated in a long hole 12 of a support plate 11. Two groups of symmetrical motion control parts are arranged beneath the support plate 11. Each motion control part is composed of a wheel disk 21 on the shaft 25 of the motor, a pin 22 at an eccentric position on the wheel disk 21, a connecting rod 23 and a rocking beam 24 connected in turn. The connecting point 27 of the connecting rod 23 with the rocking beam 24 is at the middle of the rocking beam 24. A massage wheel 31 is arranged at the upper end of the rocking beam 24. The massage wheel 31 is connected to the rocking beam 24 by using a hinge structure. Each group of motion control parts comprise 2˜3 kits, and are distributed laterally in parallel with the width of the distributed area being 5˜10 cm. In order to make the vertexes of a plurality of massage wheels 31 conform to the concave convex of the curve surface of the planta pedis in a movement process, the massage wheels at the inner side of the feet are set to be a little higher than those at the outer side of the feet, i.e., the eccentric distances of the pins 22 on the wheel disks 21 of each group are made to increment in turn laterally, and the lengths of the rocking beams 24 of each group are made to increment laterally.

When using the reciprocal foot massage device according to the present invention, after starting the motor, the shaft 25 of the motor drives the wheel disk 21 to rotate, the pin 22 at the eccentric position on the wheel disk 21 drives the connecting rod 23, i.e. the pin 22 rotates around the shaft 25 of the motor, which is equivalent to effect of a crank. The rocking beam 24 at the another end of the rocking beam 23 swings reciprocally around a rocking beam fixing shaft 26. The massage wheel 31 set on the upper end of the rocking beam 24 conducts a low-high-low upward and downward movement when moving backwards and forwards, i.e. completing a circle of a compound motion. In the course of the multiple reciprocal circulatory movements, under the pressure of the planta pedis, the plurality of massage wheels 31 roll on, press and rub the planta pedis to form an activity of pushing and pressing while protuberating to simulate manually pushing, twisting and pressing the planta pedis by fingers, and there is a process of remitting releasing strength in the process of the massage wheels 31's reciprocal pushing and pressing, which overcomes a phenomenon that general unidirectional roll, push and press is easy to rub the muscle and skin of the planta pedis excessively, makes a person to clear and activate the channels and collaterals in a scenario felt very comfortable, and promotes the blood circulation of the feet.

In the reciprocal foot massage device according to the present invention, on the surface of the massage wheel 31 may be arranged a mastoid process, the material of which is preferably made of a soft and elastic material similar to rubber. A heating or heat preservation device, a medicine underlayer and a magnetic material can be arranged on the surface of the massage wheel 31, thus in the meantime of massage, taking such multiple physical therapy functions as heat, force, magnetism or medicine, promoting the telangiectasia and blood circulation of feet, stimulating the acupuncture points of the reflex regions of the planta pedis, clearing and activating the channels and collaterals, rapidly eliminating the fatigue and aching pain of feet, and taking the effects of prophylaxis, disease treatment and health improvement.

While the preferred embodiment of the present invention has been described in conjunction with the drawings, the present invention is not limited to the above embodiment. The above embodiment is only illustrative and not limitative. Without departing from the spirit of the present invention and the scope sought for protection by the claims, a person skilled in the art can further make a lot of forms, all of which belong to the protection scope of the present invention.

We claim:

1. A reciprocal foot massage device, comprising a motor and a massage part situated in a hole of a support plate, characterized in that two groups of symmetrical motion control parts are arranged beneath the support plate; each motion control part is composed of a wheel disk on the shaft of the motor, a pin at an eccentric position on the wheel disk, a connecting rod and a rocking beam connected in turn; the connecting rod is connected to the middle of the rocking beam; a massage wheel is arranged at the upper end of the rocking beam; and each group of motion control parts comprise 2˜3 kits, and are distributed laterally in parallel.

2. The reciprocal foot massage device according to claim 1, wherein the width of the distributed area of each group of motion control parts is 5˜10 cm.

3. The reciprocal foot massage device according to claim 1, wherein the eccentric distances of the pins on each group of wheel disks increment in turn laterally.

4. The reciprocal foot massage device according to claim 1, wherein each group of rocking beams increment laterally.

5. The reciprocal foot massage device according to claim 1, wherein the massage wheel is connected to the rocking beam by using a hinge structure.

6. The reciprocal foot massage device according to claim 1, wherein the massage wheels adopt an elastic material.

7. The reciprocal foot massage device according to claim 1, wherein on the surface of the massage wheel is arranged a mastoid process, a heating device, a medicine underlayer or a magnetic material.
